(19) United States
(12) Patent Application Publication
(10) Pub. No.: US 2021/0324241 A1
(43) Pub. Date: Oct. 21, 2021

(54) ADHESIVE COMPOSITION AND USE THEREOF FOR ENABLING DETECTION OF LEAKAGES IN FULLY-ADHERED ROOF SYSTEMS

(71) Applicant: SIKA TECHNOLOGY AG, Baar (CH)

(72) Inventors: Wilfried CARL, Wädenswil (CH); Patricia HEIDTMAN, Kriens (CH)

(73) Assignee: SIKA TECHNOLOGY AG, Baar (CH)

(21) Appl. No.: 17/273,356

(22) PCT Filed: Sep. 4, 2019
(86) PCT No.: PCT/EP2019/073537

§ 371 Date: Mar. 4, 2021

(30) Foreign Application Priority Data
Sep. 4, 2018 (EP) 18192431.7

(51) Int. Cl. C09J 7/30; C09J 201/00; C08L 33/02; C08L 27/06; C09J 11/04; E04D 5/14

(52) U.S. Cl. CPC C09J 7/30; C09J 201/00; E04D 5/148; C08L 27/06; C09J 11/04; C08L 33/02

(57) ABSTRACT

An adhesive composition and use thereof for providing adhered roof systems, the adhesive composition including at least one elastomer, at least one organic solvent, at least one powdered superabsorber polymer, and at least one color pigment. The method includes preparing an adhered roof system, an adhered roof system, and the use of color pigments in an anhydrous adhesive composition for enabling leak detection in adhered roof systems by visual inspection.

### TECHNICAL FIELD

The invention relates to the field of adhesive compositions and use thereof for providing fully-adhered roof systems.

### BACKGROUND OF THE INVENTION

In the field of construction polymeric sheets, which are often referred to as membranes or panels, are used to protect underground and above ground constructions, such as basements, tunnels, and flat and low-sloped roofs, against penetration water. Waterproofing membranes are applied, for example, to prevent ingress of water through cracks that develop in the concrete structure due to building settlement, load deflection or concrete shrinkage. Roofing membranes used for waterproofing of flat and low-sloped roof structures are typically provided as single-ply or multi-ply membrane systems. In a single-ply system, the roof substrate is covered using a roofing membrane composed of single waterproofing layer, which is can be mechanically stabilized with a reinforcement layer, typically a layer of fiber material. In multi-ply systems, a roofing membrane composed of multiple layers of different or similar materials is used. Single-ply roofing membranes have the advantage of lower production costs compared to the multi-ply membranes but they are also less resistant to mechanical damages caused by punctures of sharp objects.

Commonly used materials for waterproofing and roofing membranes include plastics, in particular thermoplastics such as plasticized polyvinylchloride (p-PVC), thermoplastic olefins (TPE-O, TPO), and elastomers such as ethylene-propylene diene monomer (EPDM). The membranes are typically delivered to a construction site in form of rolls, transferred to the place of installation, unrolled, and adhered to the substrate to be waterproofed. The substrate on which the membrane is adhered may be comprised of variety of materials depending on the installation site. The substrate may, for example, be a concrete, metal, or wood deck, or it may include an insulation board or recover board and/or an existing membrane.

The roofing membranes must be secured to the roof substrate to provide sufficient mechanical strength to resist the shearing forces applied on it, for example due to high wind loads. The roofing membrane can be mechanically fastened to the roof substrate using screws and/or barbed plates. Mechanical fastening enables high strength bonding but it provides direct attachment to the roof substrate only at locations where a mechanical fastener affixes the membrane to the surface, which makes mechanically attached membranes susceptible to flutter. Membranes can also be secured to the roof substrate by adhesive bonding, which allows the formation of a “fully-adhered roof system”. In this case the majority, if not all, of the surface of the membrane is secured to the roof substrate via an adhesive layer.

Roofing membranes can be adhesively bonded to roof substrates by using a number of techniques including contact bonding and using self-adhering membranes. In contact bonding both the membrane and the surface of the roof substrate are first coated with a solvent- or water-based contact adhesive after which the membrane is contacted with the surface of the substrate. The volatile components of the contact adhesive are “flashed off” to provide a partially dried adhesive film prior to contacting the membrane with the substrate. EP 3266845 A1 discloses a contact adhesive comprising a rubber component, organic solvent, and up to 10 wt.-% of a powdered superabsorber polymer. The disclosed adhesive composition can be used for providing fully adhered roof systems with a moisture buffer, which absorbs condensate moisture during cold months and releases the absorbed moisture when the roofing membrane dries out during at summer. A fully-adhered roof system can also be prepared by using self-adhering roofing membranes having a pre-applied adhesive layer coated on one of the primary exterior surfaces of the membrane. Typically the pre-applied adhesive layer is covered with a release liner to prevent premature unwanted adhesion and to protect the adhesive layer from moisture, fouling, and other environmental factors.

At the time of use the release liner is removed and the roofing membrane is secured to the substrate without using additional adhesives. Roofing membranes having a pre-applied adhesive layer covered by release liner are also known as “peel and stick membranes”.

Irrespective of the means used for securing the roofing membrane to the roof substrate especially the single-ply membranes have a general disadvantage of having low resistance to mechanical impacts caused by objects falling on the roof. Damaging of the roofing membrane may occur, for example, during the construction or inspection phases or as a result of hailstone impacts. Such damages may also be generated by extensive traffic across the roof surface or by storing of heavy equipment on the roof, for example, during façade cleaning. Once the roofing membrane has been damaged, it cannot anymore perform its waterproofing function, which results in water ingress into the building with subsequent damage to the building structure and goods inside the building. Ideally the leakages should be detected as soon as possible after the after occurrence of the damage so that the amount of water infiltrated into the roof structure can be minimized.

There are a number of techniques available for detection of leakages in waterproofing and roofing membranes. The methods currently available are either based on one-time measurements conducted on the site or on the use of stand-alone measurement equipment, which is permanently integrated into the roof structure, such as humidity sensors. A common disadvantage of the detection methods is that they require use of specialized equipment and that the measurements can only be conducted by highly trained personnel, which increases the costs of detecting leakages. Furthermore, in many cases the use of the methods requires installation of electric devices and/or power supply units into the roofing structure. Typically, the costs of leakage detection are so high that their use is economically justified after the leakage has been already been detected by other means. For example, in the high and low voltage electric conductance methods as disclosed in ASTM D7877-14 standard, a conductive substrate (conductor) has to be installed under the roofing membrane to serve as a ground return path for the test currents. In a low voltage method, the top surface of the membrane is covered by a water film, which forms the other conductor whereas in high voltage method, another conductor is installed above the membrane. In both cases the method can only be conducted by highly trained personnel. Furthermore, in many cases the locating the exact position of the leakage is not possible with these methods.

Other methods for detecting water infiltration in roof structures are based on the use of stand-alone humidity sensors and methods based on the use of thermal imaging cameras, also known as thermographic infrared measurements. The disadvantage of the use of humidity sensors is that the sensors can measure moisture only on isolated spots on the bottom layer of the roof structure, typically on the vapor control layer. Both of these techniques also suffer from the common disadvantage that the presence but not the location of leakages can be detected. Furthermore, these methods are also prone false alarms since the presence of water in the roof structure does not necessary indicated that there is a leakage in the roofing membrane. During the cold season some moisture might condense and accumulate in the roof structure without the presence of a leakage. Even if moisture is detected, the verification of a leakage has to be conducted by a trained person. Consequently, the leakages are typically discovered only after the water has already caused significant damage to the building structures.

There thus remains a need for a novel type of fully adhered roof system, wherein the leakages can be easily detected by visual inspection means, which does not require installation of electric devices into the roof structure or use of specialized equipment.

### SUMMARY OF THE INVENTION

The object of the present invention is to provide an adhesive composition, which enables providing of a fully adhered roof system, wherein leakages can be detected by visual inspection means.

Another object of the present invention is to provide a method for preparing a fully adhered roof system wherein leakages can be detected by visual inspection means.

The subject of the present invention is an adhesive composition as defined in claim 1.

It was surprisingly found out that a solvent-based adhesive composition comprising at least one powdered superabsorber polymer and at least one color pigment enables providing a fully adhered roof system, wherein the presence and location of leakages in the roofing membrane can be detected by visual inspection means without the use of specialized equipment.

The invention is based on two technical effects obtained by using specific amount of a powdered superabsorber polymer and a color pigment in the adhesive composition of the present invention. Due to the presence of the powdered superabsorber polymer, an adhesive layer formed by using the adhesive composition starts to swell after being contacted with water infiltrated through a breach in a damaged roofing membrane. The swelling of the adhesive layer results from water being absorbed inside the superabsorber particles. In case the amount of superabsorber particles in the adhesive composition is high enough, the swelling adhesive layer fills the whole volume of the breach and forms a sealing plug against the infiltrating water. Since the adhesive composition contains a color pigment, the formation of the sealing plug can be easily spotted on the top surface of the roofing membrane. Consequently, the detection and location of leakages in fully adhered roof systems can be conducted by visual inspection means without using any specialized equipment such as thermal imaging cameras.

One of the advantages of the adhesive composition of the present invention is that leakages can be detected by visual inspection means, which does not require use of specialized equipment and/or integration of electrical devices into the roof structure. Furthermore, the leakages can be detected without the use of trained personnel.

Another advantage of the adhesive composition of the present invention is that in addition to enabling detection of leakages by visual inspection, the adhesive layer formed by using the adhesive composition also provides a “self-healing” effect, i.e. a hole in a damaged roofing membrane is automatically sealed against infiltration of water. Consequently, further damage to the roof structure is prevented even if the leakage is not immediately detected.

Still another advantage of the adhesive composition of the present invention is that the adhesive composition can be used for providing fully-adhered roof systems based on plasticized PVC and EPDM roofing membranes, wherein the adhesive layer is in direct contact with the surface of the roofing membrane.

Other aspects of the present invention are presented in other independent claims. Preferred aspects of the invention are presented in the dependent claims.

### BRIEF DESCRIPTION OF THE DRAWINGS

FIG. 1 shows a cross-section of an adhered roof system according to the present invention, wherein the presence and location of leakages can be detected by visual inspection means. The adhered roof system comprises a roof substrate (1) and a roofing membrane (2), which is directly bonded to a surface of a roof substrate (1) via an adhesive layer (3) formed by using the adhesive composition of the present invention.

FIG. 2 shows a cross-section of a State-of-the-Art adhered roof system, wherein the presence and location of leakages cannot be detected by visual inspection means. The adhered roof system comprises a roof substrate (1) and a roofing membrane (2), which is directly bonded to a surface of a roof substrate (1) via an adhesive layer (3) formed by using an adhesive composition.

### DETAILED DESCRIPTION OF THE INVENTION

The subject of the present invention is an adhesive composition comprising:

a) 40-90 wt.-% of at least one organic solvent,

b) 5-50 wt.-% of at least one elastomer,

c) 1.5-40 wt.-% of at least one powdered superabsorber polymer, and

d) 0.1-15 wt.-% of at least one color pigment, all the proportions being based on the total weight of adhesive composition.

Substance names beginning with “poly” designate substances which formally contain, per molecule, two or more of the functional groups occurring in their names. For instance, a polyol refers to a compound having at least two hydroxyl groups. A polyether refers to a compound having at least two ether groups.

The term “elastomer” refers to any natural, synthetic, or modified high molecular weight polymer or combination of polymers, which is capable of recovering from large deformations, i.e. has elastic properties. Typical elastomers are capable of being elongated or deformed to at least 200% of their original dimension under an externally applied force, and will substantially resume the original dimensions, sustaining only small permanent set (typically no more than about 20%), after the external force is released. The term “elastomer” may be used interchangeably with the term “rubber.” In particular, the term “elastomer” refers to elastomers that have not been chemically crosslinked. The term “chemically crosslinked” is understood to mean that the polymer chains forming the elastomer are inter-connected by a plurality of covalent bonds, which are mechanically and thermally stable.

The term “organic solvent” refers to an organic substance that is able of at least partially dissolving another substance. In particular, the term “organic solvent” refers to an organic solvent that is liquid at a temperature of 25° C.

The term “superabsorber polymer” or “super absorbent polymer” refers to special class of polymers that can absorb and retain extremely large amounts of a liquid relative to their own mass. For example, such superabsorber polymers may be able to absorb up to 300 times its weight of water.

The term “molecular weight” refers to the molar mass (g/mol) of a molecule or a part of a molecule, also referred to as “moiety”. The term “average molecular weight” refers to number average molecular weight (Mₙ) of an oligomeric or polymeric mixture of molecules or moieties. The molecular weight may be determined by gel permeation chromatography (GPC) using polystyrene as standard, styrene-divinylbenzene gel with porosity of 100 Angstrom, 1000 Angstrom and 10000 Angstrom as the column and tetrahydrofurane as a solvent, at 35° C.

The “amount or content of at least one component X” in a composition, for example “the amount of the at least one elastomer” refers to the sum of the individual amounts of all elastomers contained in the composition. For example, in case the composition comprises 20 wt.-% of at least one elastomer, the sum of the amounts of all elastomers contained in the composition equals 20 wt.-%.

The term “room temperature” designates a temperature of 23° C.

The adhesive composition of comprises 1.5-40 wt.-%, preferably 1.5-35 wt.-%, more preferably 3-20 wt.-%, even more preferably 3-15 wt.-%, still more preferably 3-12.5 wt.-%, in particular 3-10 wt.-%, most preferably 3-8.5 wt.-%, based on the total weight of the adhesive composition, of at least one powdered superabsorber polymer. The amount of the at least one powdered superabsorber polymer in the adhesive composition refers in the present disclosure to the amount of dry superabsorber polymer, i.e. to the amount of the at least one powdered superabsorber without the amount of water, which may be absorbed in the at least one powdered superabsorber polymer. Adhesive compositions containing the at least one powdered superabsorber polymer in an amount falling within the above cited range have been found out to be particularly suitable for providing adhered roof systems, in which the leakages can be detected by visual inspection means.

The at least one powdered superabsorber polymer and the at least one color pigment are added to the adhesive composition of the present invention to enable detection of leakages by visual inspection means in adhered roof systems. Such adhered roof systems typically comprise a roof substrate and a roofing membrane, which is bonded to a surface of the roof substrate via an adhesive layer. After the adhesive layer has been contacted with water leaking through a breach in the roofing membrane, the adhesive layer begins to swell due to absorption of water into the superabsorber polymer particles. In case the adhesive layer is flexible enough to allow the swelling to continue and the amount of superabsorber polymer is high enough, the adhesive layer protrudes though the breach and forms a sealing plug against the infiltrating water. Due to the presence of the color pigment in the adhesive composition, the presence and location of the sealing plug becomes also visible on the top surface of the roofing membrane. In case the adhesive composition used for forming the adhesive layer does not contain a superabsorber polymer or if the adhesive layer is not flexible enough, no sealing plug is formed. In this case presence and location of the leakage in the roofing membrane cannot be detected by visual inspection means.

The type of the at least one powdered superabsorber polymer present in the adhesive composition is not particularly restricted. Suitable powdered superabsorber polymers include known homo- and co-polymers of (meth)acrylic acid, (meth)acrylonitrile, (meth)acrylamide, vinyl acetate, vinyl pyrrolidone, maleic acid, maleic anhydride, itaconic acid, itaconic anhydride, vinyl sulfonic acid or hydroxyalkyl esters of such acids, wherein 0-95% by weight of the acid groups have been neutralized with alkali or ammonium groups and wherein these polymers/copolymers are crosslinked by means of polyfunctional compounds. Suitable powdered superabsorber polymers are commercially available under the trade name of HySorb® (from BASF), under the trade name of FAVOR® and Creabloc® (both from Evonik Industries), and under the trade name of AQUALIC® CA (from Nippon Shokubai).

The particle size of the at least one powdered superabsorber polymer is not particularly restricted. The at least one powdered superabsorber polymer may have a median particle size d₅₀ of less than 500 μm, preferably less than 400 μm, more preferably less than 200 μm, even more preferably less than 150 μm, most preferably less than 100 μm. According to one or more embodiments, the at least one powdered superabsorber polymer has a median particle size d₅₀ in the range of 5-250 μm, preferably 15-150 μm, more preferably 20-125 μm, most preferably 25-100 μm. The term median particle size d₅₀ refers to a particle size below which 50% of all particles by volume are smaller than the d₅₀ value.

The term “particle size” refers in the present document to the area-equivalent spherical diameter of a particle. The particle size distribution can be determined by sieve analysis according to the method as described in ASTM C136/C136M-14 standard (“Standard Test Method for Sieve Analysis of Fine and Coarse Aggregates).

The adhesive composition further comprises at least one color pigment. The term “color pigment” refers in the present disclosure to a colorant, which is preferably substantially insoluble in organic solvents, in particular substantially insoluble in the at least one organic solvent present in the adhesive composition, and which is also preferably substantially insoluble in water. The expression “substantially insoluble in water” is understood to mean that the at least one color pigment has a solubility in water at a temperature of 20° C. of not more than 0.5 g/100 g water, preferably not more than 0.1 g/100 g water, more preferably not more than 0.05 g/100 g water, even more preferably not more than 0.01 g/100 g water, still more preferably not more than 0.001 g/100 g water. The solubility of a compound in water can be measured as the saturation concentration, where adding more compound does not increase the concentration of the solution, i.e. where the excess amount of the substance begins to precipitate. The measurement for water-solubility of a compound in water can be conducted using the standard “shake flask” method as defined in the OECD test guideline 105 (adopted 27 Jul. 1995). Such color pigments have been found out as especially useful for use in adhesive compositions to enable detection of leakages by visual inspection in adhered roof systems.

The expression “substantially insoluble in the organic solvent” is understood to mean that the at least one color pigment has a solubility in the organic solvent at a temperature of 20° C. of not more than 0.5 g/100 g organic solvent, preferably not more than 0.1 g/100 g organic solvent, more preferably not more than 0.05 g/100 g organic solvent, even more preferably not more than 0.01 g/100 g organic solvent.

According to one or more embodiments, the at least one color pigment is selected from the group consisting of fluorescent and phosphorescent pigments.

Adhesive compositions containing, in addition to the at least one powdered superabsorber polymer, at least one color pigment have been found out to be suitable for providing fully-adhered roof systems, in which the leakages can be detected by visual inspection means. Furthermore, it has been found out that by using a fluorescent or phosphorescent color pigment in the adhesive composition, the visibility of a sealing plug can be further amplified, which enables a more efficient detection of leakages by visual inspection means.

Suitable fluorescent inorganic pigments include pigments that are composed primarily of crystals of oxides, sulfides, silicates, phosphates, and tungstates of Ca, Ba, Mg, Zn, and Cd. These can be obtained, for example, by adding extremely small amount of a metal, for example Cu, Ag, Bi, Pb, Mn, Cu, or Sb as an activator to an inorganic fluorescent material, such as zinc sulfide (ZnS), a heavy metal salt, such as zinc cadmium sulfide (ZnCdS) or calcium strontium sulfide (CaSrS), or a sulfide of alkaline-earth metal, such as calcium sulfide (CaS). Examples of suitable fluorescent inorganic pigments include, but are not limited to, CaS/Bi (blue), CaSrS/Bi (light blue), ZnS/Cu (green), ZnCdS/Cu (yellow), ZnS/Mn (yellow), ZnCdS/Cu (orange), ZnS/Ag (purple), ZnCdS/Cu (red-orange) and ZnS/Bi (red). Suitable fluorescent organic pigments include, but are not limited to, diaminostilbenedisulfonic acid derivatives, imidazole derivatives, coumarin derivatives, triazoles, carbazoles, pyridines, naphthalic acid, imidazolones, anthracines and other compounds which have a benzene ring.

Suitable phosphorescent pigments include, for example, strontium aluminate, strontium aluminate oxide, and other alkaline earth aluminates and alkaline earth metal aluminate oxides, strontium sulfide, calcium sulfide, zinc sulfide, zinc sulfide doped with copper, zinc sulfide doped with copper and manganese, cadmium sulfide, and phosphors represented by the general formula MO.mAl₂O₃:Eu₂+,R3+, wherein m is a number ranging from about 1.6 to about 2.2, M is Sr or a combination of Sr with Ca and Ba or both, R3+ is a trivalent metal ion or trivalent Bi or a mixture of these trivalent ions, Eu2+ is present at a level up to about 5 mol.-% of M, and R3+ is present at a level up to about 5 mol.-% of M.

Preferably, the at least one color pigment is present in the adhesive composition in an amount of at least 0.1 wt.-%, more preferably at least 0.5 wt.-%, even more preferably at least 1.0 wt.-%, based on the total weight of the adhesive composition. According to one or more embodiments, the at least one color pigment is present in the adhesive composition in an amount of 0.1-15 wt.-%, preferably 0.25-10 wt.-%, more preferably 0.5-7.5 wt.-%, most preferably 0.5-5 wt.-%, based on the total weight of the adhesive composition.

The amount of the at least one organic solvent in the adhesive composition is not particularly restricted. According to one or more embodiments, the at least one organic solvent is present in the adhesive composition in an amount of 40-90 wt.-%, preferably 50-85 wt.-%, more preferably 55-85 wt.-%, most preferably 60-80 wt.-%, based on the total weight of the adhesive composition.

The type of the at least one organic solvent contained in the adhesive composition is not particularly restricted. Typically, the type of the at least one organic solvent is selected based on the type of the at least one elastomer contained in the adhesive composition. Suitable organic solvents include solvents having a standard boiling point of not more than 250° C., preferably not more than 200° C. The term ‘standard boiling point’ refers in the present disclosure to boiling point measured at a pressure of 1 bar. The standard boiling point of a substance or composition can be determined, for example, by using an ebulliometer.

According to one or more embodiments, the at least one organic solvent has a relative evaporation rate determined according to DIN 53170:2009-08 standard of not more than 40, preferably not more than 30, more preferably not more than 20 and/or a Hildebrandt solubility parameter δ in the range of 5-40 MPa^{1/2}, more preferably 10-30 MPa^{1/2}.

The relative evaporation rate is the quotient of the evaporation time of the test liquid and that of diethyl ether as reference liquid at a temperature of 293±2 K and at a relative humidity of 65%±5%.

The Hildebrandt solubility parameter δ can be calculated using the equation:

$$δ = \sqrt{\frac{{Δ H}_{v} - RT}{{V}_{m}}} ,$$

wherein ΔHᵥ is heat of vaporization,

R is gas constant,

T is temperature, and

Vₘ is molar volume.

Organic solvents having a relative evaporation rate within the above cited ranges have been found out to be particularly preferably for use in the adhesive composition of the present invention since the adhesive composition is typically used for contact bonding, in which the adhesive is cured by evaporating the at least organic solvent. On the other hand, organic solvents having the Hildebrandt solubility parameter δ^{1/2} within the above cited ranges have been found out to be preferable for use in the adhesive composition since the at least one elastomer has a high solubility in these types of organic solvents.

Suitable organic solvents for the adhesive composition include oxygenated, aliphatic and aromatic hydrocarbon solvents, and mixtures thereof. Particularly suitable oxygenated hydrocarbon solvents include, for example, ethyl acetate, acetone, tetrahydrofuran, methyl ethyl ketone, methyl isobutyl ketone, methyl n-butyl ketone, and other ketone and ester based solvents. Particularly suitable aliphatic and aromatic hydrocarbon solvents include, for example, pentane, cyclohexene, cyclohexane, n-hexane, n-heptane, and octane, benzene, naphthalene, toluene, and xylene.

According to one or more embodiments, the at least one organic solvent is selected from the group consisting of ethyl acetate, acetone, tetrahydrofuran, methyl ethyl ketone, methyl isobutyl ketone, methyl n-butyl ketone, toluene, xylene, pentane, cyclohexene, cyclohexane, n-hexane, n-heptane, and octane. According to one or more further embodiments, the at least one organic solvent is selected from the group consisting of ethyl acetate, acetone, tetrahydrofuran, methyl ethyl ketone, methyl isobutyl ketone, and methyl n-butyl ketone. According to one or more further embodiments, the at least one organic solvent is selected from the group consisting of pentane, cyclohexene, cyclohexane, n-hexane, n-heptane, octane, benzene, naphthalene, toluene, and xylene.

Mixtures of oxygenated hydrocarbon solvents and aliphatic and/or aromatic hydrocarbon solvents may also be used. According to one or more embodiments, the at least one organic solvent comprises 65-95 wt.-%, preferably 75-90 wt.-% of at least one first organic solvent selected from the group consisting of ethyl acetate, acetone, tetrahydrofuran, methyl ethyl ketone, methyl isobutyl ketone, and methyl n-butyl ketone and 5-35 wt.-%, preferably 10-25 wt.-% of at least one second organic solvent selected from the group consisting of pentane, cyclohexene, cyclohexane, n-hexane, n-heptane, octane, benzene, naphthalene, toluene, and xylene.

The amount of the at least one elastomer in the adhesive composition is not particularly restricted. According to one or more embodiments, the at least one elastomer is present in the adhesive composition in an amount of 5-50 wt.-%, preferably 10-45 wt.-%, more preferably 10-40 wt.-%, most preferably 10-35 wt.-%, based on the total weight of the adhesive composition.

The type of the at least one elastomer is not particularly restricted. Any elastomer typically used in solvent-based solution adhesives is suitable for use in the adhesive composition of the present invention. According to one or more embodiments, the at least one elastomer is selected from the group consisting of chloroprene rubber, butyl rubber, halogenated butyl rubber, acryl nitrile rubber, natural rubber, polyisobutylene, and polyurethane rubber. According to one or more further embodiments, the at least one elastomer is selected from the group consisting of chloroprene rubber, butyl rubber, halogenated butyl rubber, acryl nitrile rubber, and natural rubber.

According to one or more embodiments, the at least one powdered superabsorber polymer is present in the adhesive composition in an amount of 3-20 wt.-%, preferably 3-15 wt.-%, more preferably 3-10 wt.-% and/or the at least one color pigment is present in the adhesive composition in an amount of 0.1-15 wt.-%, preferably 0.25-10 wt.-%, more preferably 0.5-7.5 wt.-%, even more preferably 0.5-5 wt.-% and/or the at least one organic solvent is present in the adhesive composition in an amount of 40-90 wt.-%, preferably 50-85 wt.-%, more preferably 55-85 wt.-%, even more preferably 60-80 wt.-% and/or the at least one elastomer is present in the adhesive composition in an amount of 5-50 wt.-%, preferably 10-45 wt.-%, more preferably 10-40 wt.-%, even more preferably 10-35 wt.-%, all proportions being based on the total weight of the adhesive composition.

Preferably, the at least one elastomer is substantially completely dissolved in the at least one organic solvent. The wording “substantially completely dissolved” is understood to mean that at least 90 wt.-%, preferably at least 95 wt.-%, more preferably at least 97.5 wt.-%, even more preferably at least 99 wt.-%, most preferably at least 99.5 wt.-% of the at least one elastomer is dissolved in the at least one organic solvent. Such adhesive compositions are also known as solvent-based solution adhesives. These have been found out to be particularly suitable for use as “an adhesive base” for the adhesive composition of the present invention since they can be mixed high amounts of powdered superabsorber while still providing high peel strengths in a fully-adhered roof membrane.

Preferably, the adhesive composition comprises not more than 5.0 wt.-%, more preferably not more than 3.5 wt.-%, even more preferably not more than 2.5 wt.-%, most preferably not more than 2.0 wt.-%, based on the total weight of the adhesive composition, of water. Preferably, substantially the entire amount, such as 97.5 wt.-%, preferably 99.5 wt.-% of the water contained in the adhesive composition is absorbed in the at least one powdered superabsorber polymer. Preparing adhesive compositions that are completely free of water may not be preferred since the at least one powdered superabsorber polymer typically has a moisture content in the range of 5-10 wt.-% when stored in normal atmospheric conditions (23° C., 50% relative humidity).

According to one or more embodiments, the adhesive composition is an anhydrous adhesive composition. The term “anhydrous adhesive composition” refers in the present disclosure to adhesive compositions having a water content of less than 1.0 wt.-%, preferably less than 0.5 wt.-%, excluding the amount of water that may be contained in the at least one powdered superabsorber polymer.

According to one or more embodiments, the adhesive composition further comprises at least one hydrocarbon resin and/or at least one synthetic thermosetting resin, and/or at least one adhesion enhancing resin. Suitable adhesion enhancing resins are commercially available, for example, under the trade name of TEGO®, such as TEGO® AddBond (from Evonik Industries). The at least one hydrocarbon resins is preferably selected from the group consisting of natural resins, chemically modified natural resins, and petroleum hydrocarbon resins.

Examples of suitable natural resins and chemically modified natural resins include rosins, rosin esters, phenolic modified rosin esters, and terpene resins. The term “rosin” is to be understood to include gum rosin, wood rosin, tall oil rosin, distilled rosin, and modified rosins, for example dimerized, hydrogenated, maleated and/or polymerized versions of any of these rosins. Suitable terpene resins include copolymers and terpolymers of natural terpenes, such as styrene/terpene and alpha methyl styrene/terpene resins; polyterpene resins generally resulting from the polymerization of terpene hydrocarbons, such as the bicyclic monoterpene known as pinene, in the presence of Friedel-Crafts catalysts at moderately low temperatures; hydrogenated polyterpene resins; and phenolic modified terpene resins including hydrogenated derivatives thereof.

The term “petroleum hydrocarbon resin” refers in the present document to synthetic hydrocarbon resins made by polymerizing mixtures of unsaturated monomers that are obtained from petroleum based feedstocks, such as from by-products of cracking of natural gas liquids, gas oil, or petroleum naphthas. These include also pure monomer aromatic resins, which are made by polymerizing aromatic monomer feedstocks that have been purified to eliminate color causing contaminants and to precisely control the composition of the product. Petroleum hydrocarbon resins typically have a relatively low average molecular weight, such in the range of 250-5'000 g/mol, and a glass transition temperature of above 0° C., preferably equal to or higher than 15° C., more preferably equal to or higher than 30° C.

Suitable hydrocarbon petroleum resins include C5 aliphatic petroleum hydrocarbon resins, mixed C5/C9 aliphatic/aromatic petroleum hydrocarbon resins, aromatic modified C5 aliphatic petroleum hydrocarbon resins, cycloaliphatic petroleum hydrocarbon resins, mixed C5 aliphatic/cycloaliphatic petroleum hydrocarbon resins, mixed C9 aromatic/cycloaliphatic petroleum hydrocarbon resins, mixed C5 aliphatic/cycloaliphatic/C9 aromatic petroleum hydrocarbon resins, aromatic modified cycloaliphatic petroleum hydrocarbon resins, C9 aromatic petroleum hydrocarbon resins, as well hydrogenated versions of the aforementioned resins. The notations “C5” and “C9” indicate that the monomers from which the resins are made are predominantly hydrocarbons having 4-6 and 8-10 carbon atoms, respectively. The term “hydrogenated” includes fully, substantially as well as at least partially hydrogenated resins.

Partially hydrogenated resins may have a hydrogenation level, for example, of 50%, 70%, or 90%.

Suitable synthetic thermosetting resins to be used in the adhesive composition include those materials obtained by the condensation of phenol or substituted phenol with an aldehyde. These materials may also be referred to as phenolic resins or phenol formaldehyde resins.

The adhesive composition may further comprise one or more additives and auxiliary components selected from reinforcing and non-reinforcing fillers, UV absorbers, UV stabilizers, heat stabilizers, antioxidants, flame retardants, optical brighteners, and biocides. Suitable fillers that can be used include inorganic fillers such as calcium carbonate, clays, silica, talc, titanium dioxide, magnesium oxide, zinc oxide, carbon black, and mixtures thereof. The additives, if used at all, preferably comprise not more than 20 wt.-%, more preferably not more than 15 wt.-%, most preferably not more than 10 wt.-%, of the total weight of the adhesive composition.

The preferences given above for the at least one powdered superabsorber polymer, the at least one color pigment, the at least one elastomer, and the at least one organic solvent apply equally to all subjects of the present invention unless otherwise stated.

Another subject of the present invention is a method for preparing an adhered roof system comprising steps of:

I) Applying an adhesive composition according to the present invention to at least a portion of a surface of a roof substrate to form a first continuous wet film of adhesive,

II) Providing a roofing membrane having first and second primary exterior surfaces and applying an adhesive composition according to the present invention to at least a portion of the second primary exterior surface of the roofing membrane to form a second continuous wet film of adhesive,

III) Allowing the at least one organic solvent contained in the wet adhesive films to at least partially evaporate to form a first and a second at least partially dried adhesive films suitable for contact bonding,

IV) Contacting the first at least partially dried adhesive film with the second at least partially dried adhesive film to form an adhesive bond between the roofing membrane and the roof substrate.

The adhesive composition may be applied on the surfaces of the roof substrate and roofing membrane by using any conventional means such as by using conventional rollers, power rollers, brushes, drop spreaders, squeegee, or by spraying. Preferably, the adhesive composition is applied to the surfaces of the substrate and roofing membrane by using a roller, brush, squeegee, or by spraying.

The roofing membrane is preferably sheet-like element having first and second primary exterior surfaces defining a thickness there between. The term “sheet-like element” refers in the present document to elements having a length and width at least 25 times, preferably at least 50 times, more preferably at least 150 times greater than the thickness of the element. The term “primary exterior surface of the roofing membrane” refers to the outermost primary surfaces of the roofing membrane.

The color of the at least one color pigment is preferably selected such that the adhesive composition has a color that is different from the color of the first primary exterior surface of the roofing membrane. This enables improved detection of leakages in the adhered roof system by visual inspection means. According to one or more embodiments, the at least one color pigment is selected to have a color that is different from the color of the first primary exterior surface of the roofing membrane.

According to one or more embodiments, the at least one color pigment is selected from the group consisting of fluorescent and phosphorescent pigments. Use of such color pigments in the adhesive composition further improves the detection of leakages in the adhered roof system by visual inspection means, in particular when the detection of leakages is conducted in the absence of sun light and/or artificial lightning.

The adhesive composition may be applied to cover only a portion or substantially the entire area of one of the second primary exterior surface of the roofing membrane. According to one or more embodiments, the adhesive composition is applied to cover at least 75%, preferably at least 85%, most preferably at least 90%, of the area of the second primary exterior surface of the roofing membrane. In case the same adhesive composition is used for bonding the overlapping portions of adjacent roofing membranes, the adhesive composition is preferably applied to cover substantially entire area of the second primary exterior surface of the roofing membrane. The wording “substantially entire area” is understood to mean at least 95%, preferably at least 97.5%, more preferably at least 98.5% of the entire area.

According to one or more embodiments, the adhesive composition is applied to the second primary exterior surface of the roofing membrane and/or to the surface of the roof substrate with a wet coating weight of 150-1'500 g/m², more preferably 250-1'250 g/m², most preferably 350-1'000 g/m². The term “wet coating weight” refers in the present disclosure to coating weight per unit area of the wet adhesive film before significant evaporation of the at least one organic solvent has taken place. Wet coating weights in the above cited ranges have been found out to enable sufficient adhesive bond strengths between the roofing membrane and roof substrate, which are required in adhered roof systems.

The roof substrate is preferably selected from the group consisting of an insulation board, a cover board, and an existing roofing membrane.

The detailed structure of the roofing membrane is not particularly restricted but the membrane should fulfill the general requirements as defined in DIN 20000-201:2015-08 standard. Such roofing membranes are known to a person skilled in the art and they may be produced by any conventional means, such as by way of extrusion or co-extrusion through a conventional extrusion die, calendaring or by spread coating.

According to one or more embodiments, the roofing membrane comprises a waterproofing layer having first and second major surfaces, wherein the second major surface of the waterproofing layer constitutes the second primary exterior surface of the roofing membrane. According to one or more further embodiments, the roofing membrane is a single-ply roofing membrane comprising exactly one waterproofing layer having first and second major surfaces.

The type of the waterproofing layer is not particularly restricted but it should be as waterproof as possible and not to decompose or be mechanically damaged even under prolonged influence of water or moisture. According to one or more embodiments, the waterproofing layer has an impact resistance measured according to EN 12691: 2005 standard of 200-1500 mm and/or a longitudinal and a transversal tensile strength measured at a temperature of 23° C. according to DIN ISO 527-3 standard of at least 5 MPa and/or a longitudinal and transversal elongation at break measured at a temperature of 23° C. according to DIN ISO 527-3 standard of at least 300% and/or a water resistance measured according to EN 1928 B standard of 0.6 bar for 24 hours and/or a maximum tear strength measured according to EN 12310-2 standard of at least 100 N.

Preferably, the waterproofing layer comprises at least one thermoplastic polymer, preferably selected from the group consisting of ethylene-vinyl acetate copolymer (EVA), ethylene-acrylic ester copolymers, ethylene-α-olefin co-polymers, ethylene-propylene copolymers, propylene-α-olefin copolymers, propylene-ethylene copolymers, polypropylene (PP), polyethylene (PE), polyvinylchloride (PVC), polyethylene terephthalate (PET), polystyrene (PS), polyamides (PA), chlorosulfonated polyethylene (CSPE), ethylene propylene diene rubber (EPDM), and polyisobutylene (PIB). According to one or more embodiments, the at least one thermoplastic polymer is selected from the group consisting of polyvinylchloride (PVC), low-density polyethylene (LDPE), linear low-density polyethylene (LLDPE), high-density polyethylene (HDPE), ethylene-vinyl acetate copolymer (EVA), ethylene-acrylic ester copolymers, ethylene-α-olefin copolymers, and ethylene-propylene copolymers, propylene-α-olefin copolymers, propylene-ethylene copolymers, and polypropylene (PP).

It may be preferable that the at least one thermoplastic polymer is present in the waterproofing layer in an amount of at least 15 wt.-%, more preferably at least 25 wt.-%, most preferably at least 35 wt.-%, based on the total weight of the waterproofing layer. According to one or more embodiments, the at least one thermoplastic polymer is present in the waterproofing layer in an amount of at least 50 wt.-%, preferably at least 60 wt.-%, more preferably at least 70 wt.-%, most preferably at least 85 wt.-%, based on the total weight of the waterproofing layer.

The waterproofing layer can comprise, in addition to the at least one thermoplastic polymer, auxiliary components, for example, UV- and heat stabilizers, antioxidants, plasticizers, flame retardants, fillers, dyes, pigments such as titanium dioxide and carbon black, matting agents, antistatic agents, impact modifiers, biocides, and processing aids such as lubricants, slip agents, antiblock agents, and denest aids. The total amount of these auxiliary components is preferably not more than 35 wt.-%, more preferably not more than 25 wt.-%, most preferably not more than 15 wt.-%, based on the total weight of the waterproofing layer. In case the waterproofing layer comprises a dyes and/or pigments, the color of the waterproofing layer is preferably selected such that it is different from the color adhesive composition, i.e. different from the at least one color pigment contained in the adhesive composition.

The waterproofing layer may further comprise a reinforcing layer, which is fully embedded into the waterproofing layer. By the expression “fully embedded” is meant that the reinforcing layer is fully covered by the matrix of the waterproofing layer. It may, however, be also possible or even preferred that the waterproofing layer does not contain any reinforcing layers. The type of the reinforcement layer, if used, is not particularly restricted. For example, the reinforcement layers commonly used for improving the dimensional stability of thermoplastic roofing membranes can be used. According to one or more embodiments, the reinforcement layer is a layer of fiber material.

The term “fiber material” designates in the present document materials composed of fibers comprising or consisting of, for example, organic, inorganic or synthetic organic materials. Examples of organic fibers include, for example, cellulose fibers, cotton fibers, and protein fibers. Particularly suitable synthetic organic materials include, for example, polyester, homopolymers and copolymers of ethylene and/or propylene, viscose, nylon, and polyamides. Fiber materials composed of inorganic fibers are also suitable, in particular, those composed of metal fibers or mineral fibers, such as glass fibers, aramid fibers, wollastonite fibers, and carbon fibers. Inorganic fibers, which have been surface treated, for example, with silanes, may also be suitable. The fiber material can comprise short fibers, long fibers, spun fibers (yarns), or filaments. The fibers can be aligned or drawn fibers. It may also be advantageous that the fiber material is composed of different types of fibers, both in terms of geometry and composition.

The layer of fiber material is preferably selected from the group consisting of non-woven fabrics, woven fabrics, and non-woven scrims, and combinations thereof. The term “non-woven fabric” designates in the present document materials composed of fibers, which are bonded together by using chemical, mechanical, or thermal bonding means, and which are neither woven nor knitted. Non-woven fabrics can be produced, for example, by using a carding or needle punching process, in which the fibers are mechanically entangled to obtain the nonwoven fabric. In chemical bonding, chemical binders such as adhesive materials are used to hold the fibers together in a non-woven fabric. The term “non-woven scrim” designates in the present document web-like non-woven products composed of yarns, which lay on top of each other and are chemically bonded to each other. Typical materials for non-woven scrims include metals, fiberglass, and plastics, in particular polyester, polypropylene, polyethylene, and polyethylene terephthalate (PET).

It can be advantageous that the roofing membrane further comprises a top-coating covering at least a portion of the first major surface of the waterproofing layer. The top-coating may comprise UV-absorbers and/or thermal stabilizers to protect the waterproofing layer from damaging influence of sunlight. The top-coating may also comprise color pigments in order to provide the waterproofing layer with a desired color. Preferably, the color of the top-coating is selected such that it is different from the color of adhesive composition, i.e. different from the at least one color pigment contained in the adhesive composition.

According to one or more further embodiments, the roofing membrane is a multi-ply roofing membrane comprising a first and a second waterproofing layers having first and second major surfaces, wherein the second major surface of the second waterproofing layer constitutes the second primary exterior surface of the roofing membrane.

The preferences given above for the waterproofing layer apply also to the first and second waterproofing layers of the multi-ply roofing membrane. The first and second waterproofing layers are preferably directly bonded to each other over at least part of their opposing major surfaces, i.e. at least part of the second major surface of the first waterproofing layer is directly bonded to at least part of the first major surface of the second waterproofing layer. The composition of first and second waterproofing layers may be same or different. Furthermore, the multi-ply roofing membrane may comprise a top-coating covering at least part of the first major surface of the first waterproofing layer.

The preferred thickness of the waterproofing layer depends on the embodiment of the roofing membrane. In case the roofing membrane is a singly-ply roofing membrane, the waterproofing layer preferably has a thickness determined by using the method as defined in DIN EN 1849-2 standard in the range of 0.5-5 mm, more preferably 0.5-3.5 mm, even more preferably 0.5-2.5 mm, most preferably 0.75-2 mm. In case the roofing membrane is a multi-ply roofing membrane, the first and second waterproofing layers preferably have a thickness determined by using the method as defined in DIN EN 1849-2 standard in the range of 0.25-5 mm, more preferably 0.25-2.5 mm, even more preferably 0.5-2 mm, most preferably 0.5-1.5 mm.

Furthermore, the roofing membrane preferably has a thickness determined by using the method as defined in DIN EN 1849-2 standard in the range of 0.5-10 mm, preferably 0.5-7.5 mm, more preferably 0.75-5 mm, even more preferably 0.5-2.5 mm, most preferably 0.75-2 mm. The roofing membrane is typically provided in a form of a sheet having a width of 1-5 m and length of several times the width.

The preferences given above for the roofing membrane, waterproofing layer(s), and the roof substrate apply equally to all subjects of the present invention unless otherwise stated.

Another subject of the present invention is an adhered roofing system comprising a roof substrate and a roofing membrane having first and second primary exterior surfaces, wherein at least a portion of the second primary exterior surface of the roofing membrane is adhesively adhered to a surface of the roof substrate using an anhydrous adhesive composition comprising at least one color pigment and at least one powdered superabsorber polymer.

The expression “adhesively adhered using anhydrous adhesive composition” is understood to mean that at least a portion of one of the second primary exterior surface of the roofing membrane is directly bonded to the surface of the roof substrate via an adhesive layer formed by using the anhydrous adhesive composition. The expression “directly bonded” is understood to mean in the context of the present disclosure that no further layer or substance is present between the second primary exterior surface of the roofing membrane and the adhesive layer.

The color of the at least one color pigment is preferably selected such that the anhydrous adhesive composition has a color that is different from the color of the first primary exterior surface of the roofing membrane. This enables improved detection of leakages in the adhered roof system by visual inspection means. According to one or more embodiments, the at least one color pigment is selected to have a color that is different from the color of the first primary exterior surface of the roofing membrane.

According to one or more embodiments, at least 75%, preferably at least 85%, most preferably at least 90%, of the area of the second primary exterior surface of the roofing membrane is directly bonded to the surface of the roof substrate via an adhesive layer formed by using the anhydrous adhesive composition. According to one or more further embodiments, substantially entire area of one of the second primary exterior surface of the roofing membrane is directly bonded to the surface of the roof substrate via an adhesive layer formed by using the anhydrous adhesive composition. The wording “substantially entire area” is understood to mean at least 95%, preferably at least 97.5%, more preferably at least 98.5% of the entire area.

The particles of the at least one powdered superabsorber polymer are preferably distributed throughout the entire volume of the adhesive layer. The term “distributed throughout” is understood to mean that essentially all portions of the adhesive layer contain superabsorber particles but it does not necessarily imply that the distribution of the superabsorber particles is completely uniform in the adhesive layer, i.e. the adhesive layer may contain regions, which have a slightly higher concentration of superabsorber particles than other regions.

According to one or more embodiments, the at least one color pigment is selected from the group consisting of fluorescent and phosphorescent pigments. Use of such color pigments in the adhesive composition further improves the detection of leakages in the adhered roof system by visual inspection means, in particular when the detection of leakages is conducted in the absence of sun light and/or artificial lightning. Suitable fluorescent and phosphorescent pigments to be used in the adhesive composition include the ones considered suitable for use in the adhesive composition of the present invention as discussed above.

Preferably, the at least one color pigment is present in the anhydrous adhesive composition in an amount of at least 0.1 wt.-%, more preferably at least 0.5 wt.-%, even more preferably at least 1.0 wt.-%, based on the total weight of the anhydrous adhesive composition. According to one or more embodiments, the at least one color pigment is present in the anhydrous adhesive composition in an amount of 0.1-15 wt.-%, preferably 0.5-10 wt.-%, more preferably 0.5-7.5 wt.-%, even more preferably 1.0-5.0 wt.-%, based on the total weight of the anhydrous adhesive composition.

Preferably, the at least one powdered superabsorber is present in the anhydrous adhesive composition in an amount of at least 1.5 wt.-%, preferably at least 3 wt.-%, based on the total weight of the anhydrous adhesive composition. According to one or more embodiments, the at least one powdered superabsorber is present in the anhydrous adhesive composition in an amount of 1.5-40 wt.-%, preferably 1.5-35 wt.-%, more preferably 3-20 wt.-%, even more preferably 3-15 wt.-%, most preferably 3-10 wt.-%, based on the total weight of the anhydrous adhesive composition.

According to one or more embodiments, the anhydrous adhesive composition further comprises at least one organic solvent and at least one elastomer.

According to one or more embodiments, the at least one organic solvent has a relative evaporation rate determined according to DIN 53170:2009-08 standard of not more than 40, preferably not more than 30, more preferably not more than 20 and/or a Hildebrandt solubility parameter δ in the range of 5-40 MPa^{1/2}, more preferably 10-30 MPa^{1/2}.

According to one or more embodiments, the at least one elastomer is selected from the group consisting of chloroprene rubber, butyl rubber, halogenated butyl rubber, acryl nitrile rubber, natural rubber, polyisobutylene, and polyurethane rubber. According to one or more further embodiments, the at least one elastomer is selected from the group consisting of chloroprene rubber, butyl rubber, halogenated butyl rubber, acryl nitrile rubber, and natural rubber.

The preferred thickness of the adhesive layer depends on the embodiment of the anhydrous adhesive composition. According to one or more embodiments, the adhesive layer has a thickness determined by using the method as defined in DIN EN 1849-2 standard of 10-2'000 μm, preferably 25-1'500 μm, more preferably 50-1'000 μm, even more preferably 50-500 μm, most preferably 75-350 μm.

According to one or more embodiments, the adhesive layer formed by using the anhydrous adhesive composition has a water absorbing capacity, measured according to ASTM D570 standard, in the range of 50-1000 g/m², preferably 100-1000 g/m², more preferably 150-900 g/m². Even though powdered superabsorber polymers are typically able to absorb up to the 300 times of their weight of water in a state of free expansion, their water absorbing capacity is significantly reduced when they are provided in mixtures with other components of the anhydrous adhesive composition. Without being bound to any theory, it is considered likely that the water absorbing capacity of the at least one powdered superabsorber is limited due to the restoring network forces of the at least one elastomer contained in the adhesive layer.

According to one or more embodiments, the anhydrous adhesive composition is the adhesive composition of the present invention.

According to one or more embodiments, the roofing membrane comprises a waterproofing layer having first and second major surfaces, wherein the second major surface of the waterproofing layer constitutes the second primary exterior surface of the roofing membrane. In these embodiments, the second major surface of the waterproofing layer is directly bonded to the surface of the roof substrate via an adhesive layer formed by using the anhydrous adhesive composition. The waterproofing layer may further comprise a reinforcing layer, which is fully embedded into the waterproofing layer. It may, however, be also possible or even preferred that the waterproofing layer does not contain any reinforcing layers.

According to one or more further embodiments, the roofing membrane is a single-ply roofing membrane comprising exactly one waterproofing layer having first and second major surfaces. According to one or more further embodiments, the roofing membrane is a multi-ply roofing membrane comprising a first and a second waterproofing layers having first and second major surfaces, wherein the second major surface of the second waterproofing layer constitutes the second primary exterior surface of the roofing membrane.

The roof substrate is preferably selected from the group consisting of an insulation board, a cover board, and an existing roofing membrane.

Still another subject of the present invention is use of at least one color pigment in an anhydrous adhesive composition for enabling detection of leakages in an adhered roof system by visual inspection means, the adhered roof system comprising:

i) A roof substrate and

ii) A roofing membrane having first and second primary exterior surfaces, wherein at least a portion of the second primary exterior surface of the roofing membrane is adhesively adhered to a surface of the roof substrate via an adhesive layer formed by using the anhydrous adhesive composition comprising the at least one color pigment and at least one powdered superabsorber polymer.

The wording “detection of leakages by visual inspection means” is understood to mean in the context of the present disclosure that a human viewer can visually detect the presence and location of a leakage with the unaided eye (excepting standard corrective lenses adapted to compensate for near-sightedness, farsightedness, or stigmatism, or other corrected vision). The detection of leakages by visual inspection means can be conducted by making direct visual observations on the first primary exterior surface of the roofing membrane of the adhered roof system. Furthermore, the detection of leakages can be conducted by making visual observations on recorded images of the first primary exterior surface of the roofing membrane of the adhered roof system obtained. The recorded images can be obtained using any conventional equipment, such as a camera and/or a video recorder. Furthermore, the recorded images can be obtained by using an unmanned aerial drone comprising at least one camera and/or a video recorder for recording images of the first exterior surface of the roofing membrane. Aerial drones are well known in the art and the basic setup of the aerial drone is known to a person skilled in the art.

The expression “adhesively adhered via an adhesive layer formed by using anhydrous adhesive composition” is understood to mean that at least a portion of the second primary exterior surface of the roofing membrane is directly bonded to the surface of the roof substrate via an adhesive layer, which has been obtained by using the anhydrous adhesive composition, i.e. by applying the anhydrous adhesive composition to the second primary surface of the waterproofing membrane and/or to the surface of the substrate. The expression “directly bonded” is understood to mean in the context of the present disclosure that no further layer or substance is present between the second primary exterior surface of the roofing membrane and the adhesive layer.

Preferably, the at least one color pigment has a solubility in water at a temperature of 20° C. of not more than 0.5 g/100 g water, preferably not more than 0.1 g/100 g water, more preferably not more than 0.05 g/100 g water, even more preferably not more than 0.01 g/100 g water, still more preferably not more than 0.001 g/100 g water. Such color pigments have been found out as especially useful for use in anhydrous adhesive compositions to enable detection of leakages by visual inspection in adhered roof systems.

The color of the at least one color pigment is preferably selected such that the adhesive layer has a color that is different from the color of the first primary exterior surface of the roofing membrane. This enables improved detection of leakages in the adhered roof system by visual inspection means. According to one or more embodiments, the at least one color pigment has a color that is different from the color of the first primary exterior surface of the roofing membrane.

According to one or more embodiments, the use of at least one color pigment in an anhydrous adhesive composition for enabling detection of leakages in an adhered roof system by visual inspection means is based on a process, in which the adhesive layer begins to swell after having been contacted with water leaking through a breach in the roofing membrane and forms a sealing plug, the presence and location of which can be detected by visual inspection of the first primary surface of the roofing membrane.

The adhesive layer begins to swell when contacted with water leaking through a breach of the membrane due to the absorption of water into the particles of the powdered superabsorber polymer. When the swelling continues, the adhesive layer eventually protrudes though the breach and forms a sealing plug against the infiltrating water. Due to the presence of the at least one color pigment in the anhydrous adhesive composition, the presence and location of the formed sealing plug becomes visible on the first primary exterior surface of the roofing membrane

According to one or more embodiments, at least 75%, preferably at least 85%, most preferably at least 90%, of the area of the second primary exterior surface of the roofing membrane is directly bonded to the surface of the roof substrate via the adhesive layer formed by using the anhydrous adhesive composition. According to one or more further embodiments, substantially entire area of one of the second primary exterior surface of the roofing membrane is directly bonded to the surface of the roof substrate via the adhesive layer formed by using the anhydrous adhesive composition. The wording “substantially entire area” is understood to mean at least 95%, preferably at least 97.5%, more preferably at least 98.5% of the entire area.

The particles of the at least one powdered superabsorber polymer are preferably distributed throughout the entire volume of the adhesive layer. The term “distributed throughout” is understood to mean that essentially all portions of the adhesive layer contain superabsorber particles but it does not necessarily imply that the distribution of the superabsorber particles is completely uniform in the adhesive layer, i.e. the adhesive layer may contain regions, which have a slightly higher concentration of superabsorber particles than other regions.

According to one or more embodiments, the at least one color pigment is selected from the group consisting of fluorescent and phosphorescent pigments. Use of such color pigments in the anhydrous adhesive composition further improves the detection of leakages in the adhered roof system by visual inspection means, in particular when the detection of leakages is conducted in the absence of sun light and/or artificial lightning. Suitable fluorescent and phosphorescent pigments to be used in the adhesive composition include the ones considered suitable for use in the adhesive composition of the present invention as discussed above.

Preferably, the at least one color pigment is present in the anhydrous adhesive composition in an amount of at least 0.1 wt.-%, more preferably at least 0.5 wt.-%, even more preferably at least 1.0 wt.-%, based on the total weight of the anhydrous adhesive composition. According to one or more embodiments, the at least one color pigment is present in the anhydrous adhesive composition in an amount of 0.1-15 wt.-%, preferably 0.5-10 wt.-%, more preferably 0.5-7.5 wt.-%, even more preferably 1.0-5.0 wt.-%, based on the total weight of the anhydrous adhesive composition.

Preferably, the at least one powdered superabsorber is present in the anhydrous adhesive composition in an amount of at least 1.5 wt.-%, preferably at least 3 wt.-%, based on the total weight of the anhydrous adhesive composition. According to one or more embodiments, the at least one powdered superabsorber is present in the anhydrous adhesive composition in an amount of 1.5-40 wt.-%, preferably 1.5-35 wt.-%, more preferably 3-20 wt.-%, even more preferably 3-15 wt.-%, most preferably 3-10 wt.-%, based on the total weight of the anhydrous adhesive composition.

According to one or more embodiments, the anhydrous adhesive composition further comprises at least one organic solvent and/or at least one elastomer.

According to one or more embodiments, the at least one organic solvent has a relative evaporation rate determined according to DIN 53170:2009-08 standard of not more than 40, preferably not more than 30, more preferably not more than 20 and/or a Hildebrandt solubility parameter 6 in the range of 5-40 MPa^{1/2}, more preferably 10-30 MPa^{1/2}.

According to one or more embodiments, the at least one elastomer is selected from the group consisting of chloroprene rubber, butyl rubber, halogenated butyl rubber, acryl nitrile rubber, natural rubber, polyisobutylene, and polyurethane rubber. According to one or more further embodiments, the at least one elastomer is selected from the group consisting of chloroprene rubber, butyl rubber, halogenated butyl rubber, acryl nitrile rubber, and natural rubber.

The amount of the at least one elastomer in the anhydrous adhesive composition is not particularly restricted. According to one or more embodiments, the at least one elastomer is present in the anhydrous adhesive composition in an amount of 2.5-50 wt.-%, preferably 5-45 wt.-%, more preferably 10-40 wt.-%, most preferably 10-35 wt.-%, based on the total weight of the adhesive composition.

Preferably, the anhydrous adhesive composition comprises not more than 5.0 wt.-%, more preferably not more than 3.5 wt.-%, even more preferably not more than 2.5 wt.-%, still more preferably not more than 1.5 wt.-%, in particular not more than 1.0 wt.-%, based on the total weight of the adhesive composition, of water. Preferably, substantially the entire amount, such as 97.5 wt.-%, preferably 99.5 wt.-% of the water contained in the anhydrous adhesive composition is absorbed in the at least one powdered superabsorber polymer. Preparing anhydrous adhesive compositions that are completely free of water may not be preferred since the at least one powdered superabsorber polymer typically has a moisture content in the range of 5-10 wt.-% when stored in normal atmospheric conditions (23° C., 50% relative humidity).

According to one or more embodiments, the anhydrous adhesive composition further comprises at least one hydrocarbon resin. The at least one hydrocarbon resins is preferably selected from the group consisting of natural resins, chemically modified natural resins, and petroleum hydrocarbon resins.

According to one or more embodiments, the at least one hydrocarbon resin has a softening point measured by Ring and Ball method according to DIN EN 1238 in the range of 65-200° C., preferably 75-160° C., more preferably 75-150° C., even more preferably 85-140° C. and/or a glass transition temperature (T_{g}) determined by differential scanning calorimetry method (DSC) according to ISO 11357 standard using a heating rate of 2° C./min of at or above 0° C., more preferably at or above 15° C., even more preferably at or above 30° C., still more preferably at or above 45° C.

According to one or more embodiments, the at least one hydrocarbon resin is present in the adhesive sealant composition in an amount of 0.5-55 wt.-%, preferably 1-45 wt.-%, more preferably 1.5-40 wt.-%, even more preferably 2.5-35 wt.-%, still more preferably 2.5-30 wt.-%, such as 1-25 wt.-%, based on the total weight of the anhydrous adhesive composition.

The anhydrous adhesive composition may further comprise one or more additives and auxiliary components selected from reinforcing and non-reinforcing fillers, UV absorbers, UV stabilizers, heat stabilizers, antioxidants, flame retardants, optical brighteners, and biocides. Suitable fillers that can be used include inorganic fillers such as calcium carbonate, clays, silica, talc, titanium dioxide, magnesium oxide, zinc oxide, carbon black, and mixtures thereof. The additives, if used at all, preferably comprise not more than 35 wt.-%, more preferably not more than 25 wt.-%, most preferably not more than 15 wt.-%, of the total weight of the anhydrous adhesive composition.

The preferred thickness of the adhesive layer depends on the embodiment of the anhydrous adhesive composition. According to one or more embodiments, the adhesive layer has a thickness determined by using the method as defined in DIN EN 1849-2 standard of 10-2'000 μm, preferably 25-1'500 μm, more preferably 50-1'000 μm, even more preferably 50-500 μm, most preferably 75-350 μm.

According to one or more embodiments, the adhesive layer has a water absorbing capacity, measured according to ASTM D570 standard, in the range of 50-1000 g/m², preferably 100-1000 g/m², more preferably 150-900 g/m². Even though powdered superabsorber polymers are typically able to absorb up to the 300 times of their weight of water in a state of free expansion, their water absorbing capacity is significantly reduced when they are provided in mixtures with other components of the anhydrous adhesive composition. Without being bound to any theory, it is considered likely that the water absorbing capacity of the at least one powdered superabsorber is limited due to the restoring network forces of the at least one elastomer contained in the adhesive layer.

According to one or more embodiments, the roofing membrane comprises a waterproofing layer having first and second major surfaces, wherein the second major surface of the waterproofing layer constitutes the second primary exterior surface of the roofing membrane. In these embodiments, the second major surface of the waterproofing layer is directly bonded to the surface of the roof substrate via the adhesive layer formed by using the anhydrous adhesive composition. The waterproofing layer may further comprise a reinforcing layer, which is fully embedded into the waterproofing layer. It may, however, be also possible or even preferred that the waterproofing layer does not contain any reinforcing layers.

According to one or more further embodiments, the roofing membrane is a single-ply roofing membrane comprising exactly one waterproofing layer having first and second major surfaces. According to one or more further embodiments, the roofing membrane is a multi-ply roofing membrane comprising a first and a second waterproofing layers having first and second major surfaces, wherein the second major surface of the second waterproofing layer constitutes the second primary exterior surface of the roofing membrane.

The roof substrate is preferably selected from the group consisting of an insulation board, a cover board, and an existing roofing membrane.

According to one or more embodiments, the adhered roof system is obtained by using the method for preparing an adhered roof system according to the present invention.

Still another subject of the present invention is a method for detecting leakages in an adhered roof system comprising:

i) A roof substrate and

ii) A roofing membrane having first and second primary exterior surfaces, wherein at least a portion of the second primary exterior surface of the roofing membrane is adhesively adhered to a surface of the roof substrate via an adhesive layer formed by using an anhydrous adhesive composition comprising at least one powdered superabsorber polymer and at least one color pigment, wherein the method comprises steps of:

A) Contacting the adhesive layer with water leaking through a breach in the roofing membrane, wherein the adhesive layer begins to swell due to absorption of water into the at least one powdered superabsorber polymer,

B) Letting the swelling to continue, wherein the adhesive layer protrudes through the breach and forms a sealing plug against infiltrating water, and

C) Detecting the presence and location of the sealing plug by visual inspection means.

The color of the at least one color pigment is preferably selected such that the adhesive layer has a color that is different from the color of the first primary exterior surface of the roofing membrane. This enables improved detection of leakages in the adhered roof system by visual inspection means. According to one or more embodiments, the at least one color pigment has a color that is different from the color of the first primary exterior surface of the roofing membrane.

According to one or more embodiments, at least 75%, preferably at least 85%, most preferably at least 90%, of the area of the second primary exterior surface of the roofing membrane is directly bonded to the surface of the roof substrate via the adhesive layer formed by using the anhydrous adhesive composition. According to one or more further embodiments, substantially entire area of one of the second primary exterior surface of the roofing membrane is directly bonded to the surface of the roof substrate via the adhesive layer formed by using the anhydrous adhesive composition. The wording “substantially entire area” is understood to mean at least 95%, preferably at least 97.5%, more preferably at least 98.5% of the entire area.

According to one or more embodiments, the at least one color pigment is selected from the group consisting of fluorescent and phosphorescent pigments. Use of such color pigments in the anhydrous adhesive composition further improves the detection of leakages in the adhered roof system by visual inspection means, in particular when the detection of leakages is conducted in the absence of sun light and/or artificial lightning. Suitable fluorescent and phosphorescent pigments to be used in the anhydrous adhesive composition include the ones considered suitable for use in the adhesive composition of the present invention as discussed above.

The further preferences given above for the anhydrous adhesive composition, the adhesive layer formed by using the anhydrous adhesive composition, the roofing membrane, and for the roof substrate are also applicable in context of the method for detecting leakages in an adhered roof system.

According to one or more embodiments, the adhered roof system is obtained by using the method for preparing an adhered roof system according to the present invention.

### DETAILED DESCRIPTION OF DRAWINGS

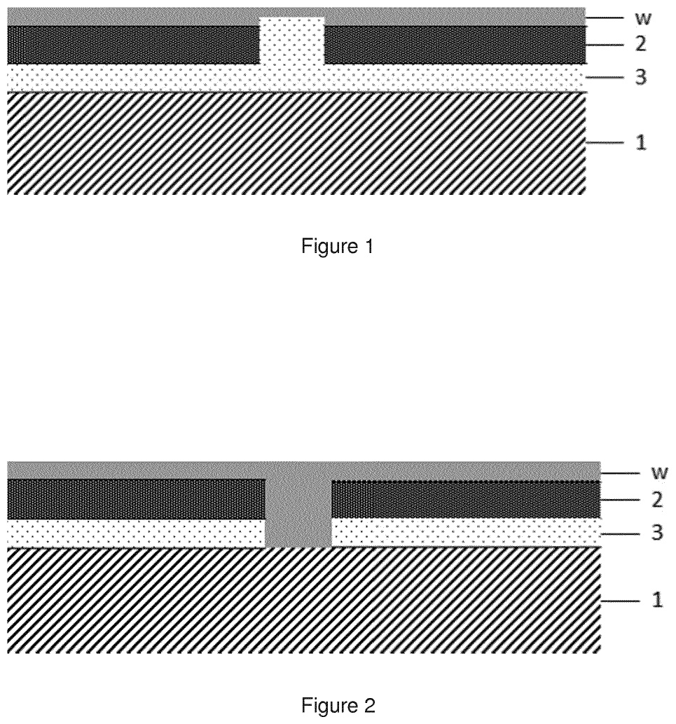

FIG. 1 shows a cross-section of an adhered roof system according to the present invention comprising a roof substrate (1) and a roofing membrane (2), which is directly bonded to a surface of the roof substrate via an adhesive layer (3). After the adhesive layer (3) has been contacted with water (w) leaking through a breach in the roofing membrane (2), the adhesive layer (3) begins to swell due to absorption of water into the superabsorber polymer particles. When the swelling continues, the adhesive layer (3) forms a sealing plug against the infiltrating water. Due to the presence of the color pigment in the adhesive layer (3), the presence and location of the sealing plug is also visible on the top surface of the roofing membrane (2).

FIG. 2 shows a cross-section of a State-of-the-Art adhered roof system comprising a roof substrate (1) and a roofing membrane (2), which is directly bonded to a surface of the roof substrate via an adhesive layer (3). In this case, the adhesive layer (3) is not able to expand after being contact with water (w) infiltrating through a breach in the roofing membrane (2). Consequently, the adhesive layer does not form a sealing plug and the presence and location of the leakage cannot be detected by visual inspection means.

### EXAMPLES

The followings compounds and products shown in Table 1 were used in the examples:

TABLE 1

| | | |
|---|---|---|
| Sarnacol ® 2170 | Contact adhesive with | Sika |
| | 22 wt.-% solids | Corporation USA |
| CABLOC ® T5066-F | Sodium polyacrylate | Evonik Industries |
| | superabsorbent polymer, | |
| | particles size of 1-60 pm | |
| Color pigment | Yellow fluorescent (neon) | RT Tritec AG |
| | color pigment | |
| Sarnafil ® G410-15 | PVC roofing membrane | Sika |
| | | Corporation USA |

Preparation of Adhesive Compositions

The tested adhesive compositions were prepared by mixing the ingredients with each other using a conventional container equipped with a suitable mixing apparatus. The composition of the reference and exemplary adhesive compositions are presented in Table 2.

Preparation of Test Specimens

The suitability of the tested adhesive compositions for providing adhered roof systems, in which leakages can be detected by visual inspection, was tested with composite test specimen comprising a glass plate and a strip of Sarnafil G410-15 PVC roofing membrane adhesively adhered to the surface of a glass plate using the tested adhesive composition.

In preparation of the test specimen, a surface of the glass plate was first evenly covered with approximately ⅔ of the total amount of the tested adhesive composition batch using a squeegee. The formed adhesive layer was then dried for approximately 30 minutes until the surface of the adhesive was not anymore tacky. Then a strip of membrane having dimensions of 10 cm×10 cm was coated with the remaining ⅓ of the tested adhesive composition batch and the formed layer of adhesive was dried for approximately 3 minutes until the adhesive was slightly moist (“stringy” according to finger test). The adhesive two layers were then contacted with each other after which the strip of roofing membrane and the glass plate were pressed together for a time of approximately 5 seconds using a weight of 1 kg. The thus obtained composite specimens were stored for one week at normal room temperature and relative humidity (23° C., 50% RH).

The total amount of the tested adhesive composition used in preparing each test specimen was 7 g, which corresponds to a total wet coating weight (layer on the glass plate+layer on the roofing membrane) of 750 g/m². The total dry coating weight of the adhesive layer, after storing the test specimens for one week at normal room temperature and relative humidity (23° C., 50% RH), was 150 g/m².

Leak Detection by Visual Inspection Means

The suitability of the tested adhesive compositions for providing adhered roof systems, in which leakages can be detected by visual inspection, was tested using the following procedure.

A rectangular hole having dimensions a 5 mm×5 mm was cut on the strip of roofing membrane of composite test specimen and the thus obtained sample was set under permanent ponding water using a plexiglass tube. Visual indication of the leakage (other than the hole) was inspected after 1, 3, and 7 days after setting the composite specimen under the influence of ponding water.

In the reference examples Ref-1 and Ref-2, the amount of the powdered superabsorber polymer in the adhesive layer was too low to enable the formation of a sealing plug, which would become visible on the top surface of the roofing membrane. In examples Ex-1 to Ex-5, three days after the beginning of the experiment a yellow plug became visible on the top surface of the roofing membrane, which indicated the presence and location of a leakage (hole). After seven days following the beginning of the experiment, the plug was able to completely fill the hole and to block the leakage.

Peel Resistance

The suitability of the adhesive compositions for providing adhered roof systems was tested by measuring of average peel resistances obtained upon peeling a strip of Sarnafil G410-15 PVC roofing membrane from surface of a plywood substrate on which strip had been adhered using the tested adhesive compositions. The strips of the Sarnafil roofing membrane were adhesively bonded to the plywood substrates using a similar procedure as described above for the preparation of composite test specimens. The peel resistance measurements were conducted using a Zwick tensile testing apparatus equipped with a 90°-peeling device.

In the peel resistance measurement, the edges of the plywood substrate were first clamped with the grips of the material testing apparatus. Subsequently, the strip of roofing membrane was peeled off from the surface of the ply wood substrate at a peeling angle of 90° and at a constant cross beam speed of 100 mm/min. The peeling of the sample strip was continued until a length of approximately 20 cm of the strip was peeled off from the surface of the substrate. The average peel resistance was calculated as average peel force per width of the strip [N/50 mm] during peeling over a length of approximately 12 cm excluding the first and last fifth of the total peeling length from the calculation.

The peel resistance values presented in Table 2 have been calculated as an average of measured peel resistances obtained with the same adhesive composition.

The result as presented in Table 2 clearly indicate that a minimum amount of the powdered superabsorber polymer in the adhesive composition is required in order to enable detection of leakages by visual inspection means. In case the amount of the superabsorber polymer was below the minimum amount, no visible plug was formed upon contacting the top surface of the roofing membrane with ponding water and the detection of the leakage was not possible by visual inspection means.

It was furthermore found out that in case the amount of the powdered superabsorber polymer in adhesive composition is increased above 40 wt.-%, a visually detectable plug is formed but the plug is not able to seal the hole against further infiltration of water. It was also estimated that in such cases the visual detection of leakages in real life applications would eventually not be possible since the formed plug was also found out to be relatively fragile and it would most likely tear off by slight forces, such as those caused by wind before the leakage could be visually detected.

TABLE 2

| Composition [wt. %] | Ref-1 | Ref-2 | Ex-1 | Ex-2 | Ex-3 | Ex-4 | Ex-5 |
|---|---|---|---|---|---|---|---|
| Sarnacol ® 2170 | 97.09 | 96.15 | 93.46 | 92.59 | 91.74 | 88.50 | 81.30 |
| Elastomer | 21.36 | 21.15 | 20.56 | 20.37 | 20.18 | 19.47 | 17.89 |
| Solvent | 75.73 | 75.00 | 72.90 | 72.22 | 71.56 | 69.03 | 63.41 |
| CABLOCO ® T5066-F | 0.00 | 0.96 | 3.74 | 4.63 | 5.50 | 8.85 | 16.26 |
| Color pigment | 2.91 | 2.88 | 2.80 | 2.78 | 2.75 | 2.65 | 2.44 |
| Total | 100.00 | 100.00 | 100.00 | 100.00 | 100.00 | 100.00 | 100.00 |
| Measurements | | | | | | | |
| Leak detection by visual | No | No | Yes | Yes | Yes | Yes | Yes |
| inspection means possible | | | | | | | |
| Peel resistance @ RT [N/50 mm] | 82 | 101 | 97 | 98 | 112 | 93 | 135 |

1. An adhesive composition comprising:
a) 40-90 wt.-% of at least one organic solvent,
b) 5-50 wt.-% of at least one elastomer,
c) 1.5-40 wt.-% of at least one powdered superabsorber polymer, and
d) 0.1-15 wt.-% of at least one color pigment, all proportions being based on the total weight of adhesive composition.

2. The adhesive composition according to claim 1, wherein the at least one color pigment is selected from the group consisting of fluorescent and phosphorescent pigments.

3. The adhesive composition according to claim 1, wherein the at least one organic solvent has a relative evaporation rate determined according to DIN 53170:2009-08 standard of not more than 40, and/or the at least one elastomer is selected from the group consisting of chloroprene rubber, butyl rubber, halogenated butyl rubber, acryl nitrile rubber, natural rubber, polyisobutylene, and polyurethane rubber.

4. The adhesive composition according to claim 1, wherein the at least one powdered superabsorber polymer is present in the adhesive composition in an amount of 3-20 wt. %, based on the total weight of the adhesive composition.

5. The adhesive composition according to claim 1, wherein the at least one elastomer is substantially completely dissolved in the at least one organic solvent and/or the adhesive composition comprises not more than 5 wt.-% of water, based on the total weight of the adhesive composition.

6. A method for preparing an adhered roof system comprising steps of:
I) applying an adhesive composition to at least a portion of a surface of a roof substrate to form a first continuous wet film of adhesive, wherein the adhesive composition is the adhesive composition according to claim 1,
II) providing a roofing membrane having first and second primary exterior surfaces and applying the adhesive composition to at least a portion of the second primary exterior surface of the roofing membrane to form a second continuous wet film of adhesive,
III) Allowing allowing the at least one organic solvent contained in the wet adhesive films to at least partially evaporate to form a first and a second at least partially dried adhesive films suitable for contact bonding, and
IV) Contacting contacting the first at least partially dried adhesive film with the second at least partially dried adhesive film to form an adhesive bond between the roofing membrane and the roof substrate.

7. An adhered roof system comprising a roof substrate and a roofing membrane having first and second primary exterior surfaces, wherein at least a portion of the second primary exterior surface of the roofing membrane is adhesively adhered to a surface of the roof substrate using an anhydrous adhesive composition comprising at least one color pigment and at least one powdered superabsorber polymer.

8. The adhered roof system according to claim 7, wherein the at least one color pigment is selected to have a color that is different from the color of the first primary exterior surface of the roofing membrane and/or wherein the at least one color pigment is selected from the group consisting of fluorescent and phosphorescent pigments.

9. The adhered roof system according to claim 7, wherein at least 75% of the area of the second primary exterior surface of the roofing membrane is directly bonded to the surface of the roof substrate via an adhesive layer formed by using the anhydrous adhesive composition.

10. The adhered roof system according to claim 7, wherein the at least one powdered superabsorber polymer is present in the anhydrous adhesive composition in an amount of 1.5-40 wt.-%, and/or the at least one color pigment is present in the anhydrous adhesive composition in an amount of 0.1-15 wt. % all proportions being based on the total weight of the anhydrous adhesive composition.

11. The adhered roof system according to claim 7, wherein the anhydrous adhesive composition further comprises at least one organic solvent, and/or at least one elastomer.

12. An adhered roof system comprising a roof substrate and a roofing membrane having first and second primary exterior surfaces, wherein
at least a portion of the second primary exterior surface of the roofing membrane is adhesively adhered to a surface of the roof substrate using an anhydrous adhesive composition comprising at least one color pigment and at least one powdered superabsorber polymer, and
the anhydrous adhesive composition is the adhesive composition according to claim 1.

13. A method comprising: adding an effective amount of least one color pigment to an anhydrous adhesive composition for enabling detection of leakages in an adhered roof system by visual inspection means, and determining whether there is a leak in the adhered roof system, the adhered roof system comprising:
i) a roof substrate and
ii) a roofing membrane having first and second primary exterior surfaces, wherein at least a portion of the second primary exterior surface of the roofing membrane is adhesively adhered to a surface of the roof substrate via an adhesive layer formed by using the anhydrous adhesive composition comprising the at least one color pigment and at least one powdered superabsorber polymer.

14. The method according to claim 13, wherein the at least one color pigment has a color that is different from the color of the first primary exterior surface of the roofing membrane.

15. The method according to claim 14, wherein the adhesive layer begins to swell after having been contacted with water leaking through a breach in the roofing membrane and forms a sealing plug, the presence and location of which can be detected by visual inspection of the first primary exterior surface of the membrane.

16. The method according to claim 13, wherein at least 75%, of the area of the second primary exterior surface of the roofing membrane is directly bonded to the surface of the roof substrate via the adhesive layer formed by using the anhydrous adhesive composition.

17. The method according to claim 13, wherein the at least one color pigment is selected from the group consisting of fluorescent and phosphorescent pigments.

18. The method according to claim 13, wherein the at least one powdered superabsorber polymer is present in the anhydrous adhesive composition in an amount of 1.5-40 wt.-%, and/or the at least one color pigment is present in the anhydrous adhesive composition in an amount of 0.1-15 wt.-%, all proportions being based on the total weight of the anhydrous adhesive composition.

19. The method according to claim 13, wherein the anhydrous adhesive composition further comprises at least one organic solvent, and/or at least one elastomer.

20. The method according to claim 13, 4-9-wherein the adhered roof system is prepared by steps of:
I) applying the anhydrous adhesive composition to at least a portion of a surface of the roof substrate to form a first continuous wet film of adhesive, wherein the anhydrous adhesive composition comprises:
a) 40-90 wt.-% of at least one organic solvent,
b) 5-50 wt.-% of at least one elastomer,
c) 1.5-40 wt.-% of at least one powdered superabsorber polymer, and
d) 0.1-15 wt.-% of the at least one color pigment, all proportions being based on the total weight of the anhydrous adhesive composition;
II) applying the anhydrous adhesive composition to at least a portion of the second primary exterior surface of the roofing membrane to form a second continuous wet film of adhesive;
III) allowing the at least one organic solvent contained in the wet adhesive films to at least partially evaporate to form a first and a second at least partially dried adhesive films suitable for contact bonding; and
IV) contacting the first at least partially dried adhesive film with the second at least partially dried adhesive film to form an adhesive bond between the roofing membrane and the roof substrate.
